(19) United States
(12) Patent Application Publication
(10) Pub. No.: US 2024/0240063 A1
(43) Pub. Date: Jul. 18, 2024

(54) COMPOSITION BASED ON A (METH)ACRYLATE MONOMER AND ZINC SALT

(71) Applicant: BOSTIK SA, COLOMBES (FR)

(72) Inventor: Guillaume MICHAUD, LYON (FR)

(21) Appl. No.: 18/290,298

(22) PCT Filed: May 16, 2022
(86) PCT No.: PCT/FR2022/050924

§ 371 Date: Nov. 12, 2023

(30) Foreign Application Priority Data
May 17, 2021 (FR) 2105103

(51) Int. Cl. C09J 133/12; C08K 5/098; C08K 5/42; C08L 33/12; C09D 133/12

(52) U.S. Cl. CPC C09J 133/12; C08L 33/12; C09D 133/12; C08K 5/098; C08K 5/42; C08L 2205/025; C09J 2433/00

(57) ABSTRACT

The present invention relates to a two-component crosslinkable composition comprising:
a component A comprising:
   a (meth)acrylate monomer;
   a reducing agent;
   a zinc salt chosen from zinc alkanesulfonates, zinc acetate, and mixtures thereof;
a component B comprising an oxidizing agent;
   and also to the uses thereof.

### FIELD OF THE INVENTION

The present invention relates to a composition based on a (meth)acrylate monomer and zinc salt.

The invention also relates to the use of said composition in the repair and/or the semi-structural or structural adhesive bonding of materials in the transportation, marine, electronics, assembly, wind power or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the 0-0 bond of the organic peroxide for example, and initiates polymerization.

However, one of the problems of this technique is oxygen inhibition. This is because the oxygen present in air in its triplet state will interact with the radicals formed at the surface of the sample, thus preventing them from initiating polymerization. This inhibition is essentially expressed at the surface since there is very little or no deep penetration of the oxygen depending on the weight per unit area deposited. In addition, the polymerization reaction is often slow for surfaces exposed to atmospheric oxygen, which surfaces, being partially polymerized, often remain tacky.

There is a need for new (meth)acrylic compositions which make it possible to at least partially solve at least one of the abovementioned drawbacks.

More particularly, there is a need for new (meth)acrylic compositions which make it possible to reduce inhibition due to atmospheric oxygen, and in particular to result in tack-free crosslinked surfaces.

There is also a need for new compositions allowing a control of the open time depending on the intended application. Adhesive bonding applications on large parts such as wind turbines require compositions that have a long open time, whereas adhesive bonding of small parts in electronics may on the contrary require very short open times.

The open time is in particular the maximum time between the application of the adhesive composition on a substrate, and the contacting of the two substrates to be bonded, without deterioration of the tackiness.

### DESCRIPTION OF THE INVENTION

### A. Composition

The present invention relates to a two-component crosslinkable composition comprising:
a component A comprising:
   a (meth)acrylate monomer;
   a reducing agent;
   a zinc salt chosen from zinc alkanesulfonates, zinc carboxylates of formula (RCOO⁻)₂, Zn²⁺ with R representing a saturated, linear or branched C1-C13 alkyl, and mixtures thereof;
a component B comprising an oxidizing agent.

The present invention relates more particularly to a two-component crosslinkable composition comprising:
a component A comprising:
   a (meth)acrylate monomer;
   a reducing agent;
   a zinc salt chosen from zinc alkanesulfonates, zinc acetate, and mixtures thereof;
a component B comprising an oxidizing agent.

### (Meth)Acrylate Monomer

The (meth)acrylate monomers can comprise one (monofunctional) or more (polyfunctional) (meth)acrylate functions.

The (meth)acrylate monomer(s) can be chosen from the group consisting of:
compounds having formula (A) below:

CH₂═C(R^{a})—COOR^{b} (A)

wherein:
R^{A} represents a hydrogen atom or an alkyl group comprising from 1 to 4 carbon atoms;
R^{b} is chosen from the group consisting of alkyls, cycloalkyls, alkenyls, cycloalkenyls, alkylaryls, arylalkyls and aryls, it being possible for said alkyls, cycloalkyls, alkenyls, cycloalkenyls, alkylaryls, arylalkyls or aryls to be optionally substituted and/or interrupted by at least one silane, one silicone, one oxygen, one halogen, one carbonyl, one hydroxyl, one ester, one urea, one urethane, one carbonate, one amine, one amide, one sulfur, one sulfonate or one sulfone;
polyethylene glycol di(meth)acrylates;
polypropylene glycol di(meth)acrylates;
tetrahydrofuran (meth)acrylates;
hydroxyalkyl (meth)acrylates such as, for example, hydroxypropyl (meth)acrylate or hydroxyethyl (meth)acrylate;
hexanediol di(meth)acrylate;
trimethylolpropane tri(meth)acrylate;
diethylene glycol di(meth)acrylate;
triethylene glycol di(meth)acrylate;
tetraethylene glycol di(meth)acrylate;
dipropylene glycol di(meth)acrylate;
di(pentamethylene glycol) di(meth)acrylate;
diglyceryl tetra(meth)acrylate;
tetramethylene di(meth)acrylate;
ethylene di(meth)acrylate;
bisphenol A mono- and di(meth)acrylates;
bisphenol F mono- and di(meth)acrylates; and
mixtures thereof.

According to one embodiment, the (meth)acrylate monomer is chosen from methyl (meth)acrylate, ethyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, 3-vinylcyclohexyl (meth)acrylate, bornyl (metha)crylate, 2,4,5-tri-t-butyl-3-vinylcyclohexyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, and mixtures thereof.

Preferably, the (meth)acrylate monomer is a methacrylate.

Preferably, the (meth)acrylate monomer is methyl methacrylate.

Component A may comprise a total content of (meth)acrylate monomer ranging from 20% to 80%, preferably from 30% to 70%, advantageously from 40% to 60% by weight relative to the total weight of said component A.

### Reducing Agent

The reducing agent can be chosen from tertiary amines, sodium metabisulfite, sodium bisulfite, transition metals, azo compounds, alpha-aminosulfones, and mixtures thereof.

Among the azo compounds, mention may for example be made of azoisobutyric acid.

Among the alpha-sulfones, mention may for example be made of bis(tolylsulfonylmethyl)benzylamine.

Among the tertiary amines, mention may for example be made of diisopropanol-p-toluidine (DIIPT); dimethyl-p-toluidine; dipropoxy-p-toluidine; dimethylaniline; N,N-dimethylaminomethylphenol; N,N-diisopropanol-p-chloroaniline; N,N-diisopropanol-p-bromoaniline; N,N-diisopropanol-p-bromo-m-methylaniline; N,N-dimethyl-p-chloroaniline; N,N-dimethyl-p-bromoaniline; N,N-diethyl-p-chloroaniline; and N,N-diethyl-p-bromoaniline; the amines having formula (I) or (II) below; and mixtures thereof:

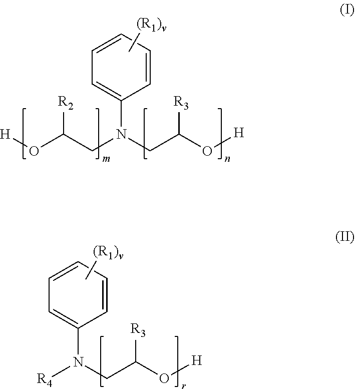

wherein:
m and n are, independently of one another, an integer ranging from 1 to 150, preferably from 1 to 100, preferentially from 1 to 72, advantageously from 1 to 36, more advantageously still from 1 to 18;
r is an integer ranging from 1 to 200, preferably from 1 to 104, preferentially from 1 to 72, advantageously from 1 to 36;
R₁ represents a radical chosen from the group consisting of a saturated or unsaturated and linear or branched alkyl comprising from 1 to 20 carbon atoms, preferably from 1 to 10 carbon atoms; of a (hetero)aryl comprising from 6 to 12 carbon atoms; of a cycloalkyl comprising from 3 to 12 carbon atoms;
v represents an integer ranging from 0 to 5;
R₂ and R₃ represent, independently of one another, a halogen atom, a hydrogen atom or a linear or branched alkyl group comprising from 1 to 12 carbon atoms, said alkyl group being optionally interrupted by at least one oxygen atom;
R₄ represents a hydrogen atom, an arylalkyl group or a linear or branched alkyl group comprising from 1 to 20 carbon atoms, preferably an alkyl group comprising from 1 to 12 carbon atoms, advantageously from 1 to 6 carbon atoms;
on the condition that m+n>2, preferably n+m 2.5.

In the abovementioned formula (I), v has a value preferably of 1 and R¹ is preferably in the para position.

The amines of formula (I) are preferably chosen from those in which:
R¹ represents a saturated or unsaturated and linear or branched alkyl comprising from 1 to 20 carbon atoms, preferably from 1 to 10 carbon atoms; preferentially, R¹ represents methyl;
m and n represent, independently of each other, an integer ranging from 1 to 18, preferably from 1 to 9, advantageously from 1 to 5;
R² and R³ represent, independently of each other, a hydrogen atom or a linear or branched alkyl group comprising from 1 to 12 carbon atoms, said alkyl group being optionally interrupted by at least one oxygen atom; preferably, R² and R³ each represent a hydrogen atom;
with m+n>2, preferably n+m 2.5.

Preferably, the amines of formula (I) are those in which:
R¹ represents a linear or branched alkyl comprising from 1 to 5 carbon atoms; preferentially,
R¹ represents methyl;
m and n represent, independently of each other, an integer ranging from 1 to 18, preferably from 1 to 9, advantageously from 1 to 5;
R² and R³ represent a hydrogen atom;
with m+n>2, preferably n+m 2.5.

Mention may be made, among the amines of formula (I), for example, of Bisomer® PTE (CAS number: 878391-30-1) sold by Geo Speciality Chemicals, Accelerator PT25E (CAS number: 878391-30-1) sold by Lanxess, N,N-bis(2-hydroxypropyl)-p-aniline (CAS number: 3077-13-2) available from Biosynth, N,N-bis(2-hydroxypropyl)-p-toluidine (CAS number: 38668-48-3) sold by BASF, Ethox ANA-10 (CAS number: 36356-83-9) available from Ethox Chemical.

In the abovementioned formula (II), v has a value preferably of 1 and R¹ is preferably in the para position.

The amines of formula (II) are preferably chosen from those in which:
R¹ represents a saturated or unsaturated and linear or branched alkyl comprising from 1 to 20 carbon atoms, preferably from 1 to 10 carbon atoms; preferentially, R¹ represents methyl;
r represents an integer ranging from 1 to 36, preferably from 1 to 18, advantageously from 1 to 10;
R³ represents a halogen atom, a hydrogen atom or a linear or branched alkyl group comprising from 1 to 12 carbon atoms, said alkyl group being optionally interrupted by at least one oxygen atom;
R⁴ represents a hydrogen atom, an arylalkyl group, or a linear or branched alkyl group comprising from 1 to 20 carbon atoms, preferably from 1 to 6 carbon atoms.

Mention may be made, among the amines of formula (II), for example, of N-(2-hydroxyethyl)-N-methylaniline (CAS number: 93-90-3) available from Sigma-Aldrich and N-(2-hydroxyethyl)-N-methyl-p-toluidine (MHPT, CAS number: 2842-44-6) available from Parchem.

Preferably, component A comprises at least one tertiary amine as reducing agent, and even more preferentially an amine of formula (I) mentioned above.

Component A may comprise a total content of reducing agent(s) ranging from 0.1% to 5%, preferably from 0.5% to 3%, by weight relative to the total weight of said component A.

### Oxidizing Agent

The oxidizing agent can be chosen from peroxides, organic salts of transition metals, compounds containing a labile chlorine, and mixtures thereof.

The peroxide can be chosen from organic peroxides, inorganic peroxides and mixtures thereof.

Mention may be made, among the inorganic peroxides, of peroxydisulfuric acid and salts thereof, such as ammonium peroxodisulfate, sodium peroxodisulfate and potassium peroxodisulfate.

Mention may be made, among the organic peroxides, of cumene hydroperoxide, para-menthane hydroperoxide, tert-butyl peroxyisobutyrate, tert-butyl peroxybenzoate, tert-butyl peroxyneodecanoate, tert-amyl peroxypivalate, acetyl peroxide, benzoyl peroxide, dibenzoyl peroxide, 1,3-bis(t-butylperoxyisopropyl)benzene, diacetyl peroxide, t-butylcumyl peroxide, tert-butyl peroxyacetate, cumyl peroxide, 2,5-dimethyl-2,5-di(t-butylperoxy)hexane, 2,5-dimethyl-2,5-di(t-butylperoxy)hex-3-yne, 4-methyl-2,2-di(t-butylperoxy)pentane and mixtures thereof.

Preferably, component B comprises benzoyl peroxide as oxidizing agent.

Component B may comprise a total content of oxidizing agent(s) ranging from 1% to 50%, preferably from 10% to 40%, by weight relative to the total weight of said component B.

The composition according to the invention may typically comprise a redox system, a reducing agent which is included in component A and an oxidizing agent which is included in component B. The following combinations may be mentioned, for example:
persulfates (oxidizing agent)/(sodium metabisulfite and/or sodium bisulfite) (reducing agents);
organic peroxides (oxidizing agent)/tertiary amines (reducing agent);
organic hydroperoxides (oxidizing agent)/transition metals (reducing agent).

### Zinc Salts

Component A comprises a zinc salt chosen from zinc alkanesulfonates, zinc carboxylates of formula (RCOO⁻)₂, Zn²⁺ with R representing a saturated, linear or branched C1-C13 alkyl, and mixtures thereof.

Preferably, component A comprises a zinc salt chosen from zinc alkanesulfonates, zinc acetate, and mixtures thereof.

Zinc salt also covers hydrated zinc salts.

In the context of the invention, and unless otherwise stated, the term “alkanesulfonates” is understood to mean aliphatic sulfonates.

The zinc alkanesulfonates may have one of the formulae (III) or (IV) below:

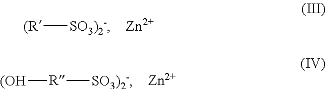

wherein R′ represents a linear or branched hydrocarbon radical comprising from 1 to 18 carbon atoms, and R″ represents a linear or branched hydrocarbon radical comprising from 2 to 18 carbon atoms.

Preferably, in formula (IV), R″ represents a linear or branched alkyl comprising from 2 to 18 carbon atoms, preferably from 2 to 6 carbon atoms, and even more preferentially from 2 to 4 carbon atoms.

According to one preferred embodiment, in the abovementioned formula (III), R′ represents a branched or linear alkyl comprising from 1 to 18 carbon atoms, preferably from 1 to 6 carbon atoms, and even more preferentially 1 carbon atom.

Among the alkanesulfonates of formula (III), mention may be made, for example, of zinc methanesulfonate (R′=methyl), zinc dodecanesulfonate (R′=C12), or zinc octadecanesulfonate (R′=C18), the zinc alkanesulfonate preferentially being zinc methanesulfonate.

Zinc alkanesulfonates are typically commercially available.

Zinc carboxylates of formula (RCOO⁻)₂, Zn²⁺ with R representing a saturated, linear or branched C1-C13 alkyl may be chosen from zinc acetate (such as, for example, zinc acetate dihydrate), zinc neodecanoate and zinc octanoate.

According to a preferred embodiment, component A comprises a zinc salt chosen from zinc carboxylates of formula (RCOO⁻)₂, Zn²⁺ with R representing a saturated, linear or branched C1-C13 alkyl, and even more preferentially from zinc acetate dihydrate and zinc neodecanoate.

Component A may comprise a total content of zinc salt(s) as defined above ranging from 0.1% to 10%, preferably from 0.5% to 5%, and more preferentially still from 0.5% to 2% by weight relative to the total weight of said component A.

### Additional Ingredients

The two-component composition may comprise at least one additional ingredient chosen from the group consisting of catalysts, fillers, antioxidants, light stabilizers/UV absorbers, metal deactivators, antistatic agents, antifogging agents, foaming agents, biocides, plasticizers, lubricants, emulsifiers, dyes, pigments, rheological agents, impact modifiers, adhesion promoters, optical brighteners, flame retardants, antisweating agents, nucleating agents, solvents and mixtures thereof.

These ingredients may be present in component A and/or component B of the composition according to the invention.

As examples of plasticizers that may be used, mention may be made of any plasticizer normally used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

Preferably, use is made of:
diisodecyl phthalate, such as, for example, sold under the name Palatinol™ DIDP by BASF,
an ester of alkylsulfonic acid and of phenol, such as, for example, sold under the name Mesamoll® by Lanxess,
diisononyl 1,2-cyclohexanedicarboxylate, such as, for example, sold under the name Hexamoll Dinch® by BASF,
pentaerythritol tetravalerate, such as, for example, sold under the name Pevalen™ by Perstorp,
the epoxidized soya bean oil as for example sold under the name Vikoflex® 7170 by Arkema.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica, such as, for example, sold under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as Crayvallac SLT sold by Arkema.

The composition according to the invention may also comprise at least one organic and/or mineral filler.

The mineral filler(s) that may be used is (are) advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically provided in the form of particles of diverse geometry. They may be, for example, spherical or fibrous or may have an irregular shape.

Preferably, the filler(s) is (are) chosen from the group consisting of clay, quartz, carbonate fillers, kaolin, gypsum, clays and mixtures thereof; preferentially, the filler(s) is (are) chosen from carbonate fillers, such as alkali metal or alkaline-earth metal carbonates, and more preferentially calcium carbonate or chalk.

These fillers can be untreated or treated, for example treated using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

The composition according to the invention may also comprise at least one adhesion promoter, preferably chosen from silanes, such as aminosilanes, epoxysilanes or acryloyl silanes, or adhesion promoters based on a phosphate ester, such as for example the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl-(2-methacryloyloxyethyl phosphate), ethyl-(2-methacryloyloxyethyl phosphate), a mixture of 2-hydroxyethyl methacrylate mono- and diphosphate esters. The composition may comprise from 0% to 5% by total weight of adhesion promoter(s).

When a solvent, in particular a volatile solvent, is present in the composition, its content is preferably less than or equal to 5% by weight, more preferably less than or equal to 3% by weight, relative to the total weight of the composition.

Preferably, the content of solvent(s) in the composition is between 0% and 5% by weight.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight, of the total weight of the composition.

The pigments may be organic or inorganic pigments.

For example, the pigment is TiO₂, in particular Kronos® 2059 sold by Kronos.

The composition can comprise an amount of from 0.1% to 3%, preferably from 1% to 3%, by weight of at least one UV stabilizer or antioxidant. These compounds are typically introduced to protect the composition from degradation resulting from a reaction with oxygen which is liable to be formed by the action of heat or light. These compounds may include primary antioxidants which trap free radicals. The primary antioxidants may be used alone or in combination with other secondary antioxidants or UV stabilizers. Mention may be made, for example, of Irganox® 1010, Irganox® B561, Irganox® 245, Irgafos® 168, Tinuvin® 328 or Tinuvin™ 770, which are sold by BASF.

The composition may comprise at least one acrylic block copolymer. The acrylic block copolymers are typically impact modifiers.

The acrylic block copolymers can be copolymers comprising:
from 1% to 99% of at least one rigid block (A), the glass transition temperature of which is greater than the ambient temperature by at least 20° C.;
from 1% to 99% by weight of at least one flexible block (B), the glass transition temperature of which is less than the ambient temperature by at least 10° C.

The copolymers may in particular be triblocks comprising rigid block/flexible block/rigid block, wherein:
at least one rigid block (A) of the copolymer advantageously consists of monomer units derived from at least one methacrylate of formula CH₂═C(CH₃)—COORᵢ where Rᵢ is a linear or branched C₁-C₃ alkyl group, a branched C₄ group, a C₃-C₈ cycloalkyl group, a C₆-C₂₀ aryl group, a C₇-C₃₀ arylalkyl group containing a C₁-C₄ alkyl group, a heterocyclic group or a heterocyclylalkyl group containing a C₁-C₄ alkyl group; and
the flexible block (B) advantageously contains:
(i) monomer units derived from at least one alkyl acrylate of formula CH₂═CH—COORⱼ where Rⱼ is a linear or branched C₁-C₁₂ alkyl group, and/or
(ii) monomer units derived from at least one methacrylate of formula CH₂═C(CH₃)—COORₖ where Rₖ is a linear C₄-C₁₂ alkyl group or a branched C₅-C₁₂ alkyl group.

The rigid block (A) preferably comprises monomer units derived from methyl methacrylate monomers.

The rigid block (A) may also comprise at least one dialkylacrylamide monomer, the linear or branched alkyl groups of which comprise from 1 to 10 carbon atoms, such as N,N-dimethylacrylamide.

The flexible block (B) preferably comprises monomer units derived from at least one monomer chosen from butyl acrylate, 2-ethylhexyl acrylate, hydroxyethyl acrylate, 2-ethylhexyl methacrylate, n-octyl acrylate, and mixtures thereof.

Preferentially, the copolymer is a polymethyl methacrylate/poly(n-butyl acrylate)/polymethyl methacrylate block copolymer.

Among the acrylic block copolymers, mention may for example be made of Nanostrength® sold by Arkema (M52 comprising 52% by weight of poly(n-butyl acrylate), or M75 comprising approximately 75% by weight of poly(n-butyl acrylate), or M65 comprising approximately 65% by weight of poly(n-butyl acrylate)).

The composition may comprise an impact modifier having a core-shell structure, typically known as a “core-shell impact modifier”.

Impact modifiers are well known to those skilled in the art, and comprise in particular core-shell impact modifiers.

The core-shell impact modifier may be in the form of spherical particles. The weight-average particle size (diameter) can range from 40 nm to 900 nm, preferably from 80 to 500 nm. The particle size can be measured with a Zetasizer (Malvern).

The core-shell impact modifier can be obtained by any process known to those skilled in the art, for example by a multistep process as described in FR 3 052 169 or in EP 2 465 884. In particular, the polymer is prepared by emulsion polymerization.

The core of the impact modifier may comprise a polymer L1 chosen from isoprene homopolymers, butadiene homopolymers, isoprene-butadiene copolymers, isoprene copolymers with a vinyl monomer, and butadiene copolymers with a vinyl monomer. The vinyl monomer can be chosen from styrene, alkylstyrene, acrylonitrile, alkyl (meth)acrylates, butadiene or isoprene.

The shell may comprise a polymer L2 obtained from (meth)acrylic monomers such as, for example, those chosen from C₁-C₁₂ alkyl (meth)acrylates. In particular, the shell comprises a polymer L2 obtained from C₁-C₄ alkyl methacrylate monomers and/or C₁-C₈ alkyl acrylate monomers.

Preferably, the shell comprises a polymer L2 obtained from methyl acrylate, propyl acrylate, isopropyl acrylate, butyl acrylate, methyl methacrylate, ethyl methacrylate, butyl methacrylate, and mixtures thereof.

According to one embodiment, the core-shell impact modifier comprises:
a core comprising a polymer L1 which is a butadiene-styrene copolymer;
a shell comprising a polymer L2 which is a poly(methyl methacrylate) (PMMA).

The core-shell impact modifiers may be commercially available. Mention may be made, for example, of Clearstrength® (for example Clearstrength® XT100) or the Durastrength® products sold by Arkema. Mention may also be made of the Paraloid products (Paraloid 2650A, Paraloid 2691A) sold by Dow Corning.

The total content of impact modifier(s) in component A may range from 2% to 30% by weight, preferably from 5% to 20% by weight relative to the total weight of component A.

The composition can comprise at least one urethane-acrylate having a number-average molecular weight of greater than or equal to 2000 g/mol, preferentially greater than or equal to 4000 g/mol.

The urethane-acrylates can be obtained by reaction between a polyol and a polyisocyanate, followed by functionalization with for example hydroxymethyl methacrylate.

There are numerous commercially available urethane-acrylates.

According to one embodiment, the component A/component B volume ratio in the composition of the invention ranges from 100/5 to 1/1, preferably from 20/1 to 1/1, preferentially from 10/1 to 1/1.

According to one preferred embodiment, the aforementioned composition comprises:
a component A comprising:
   from 20% to 80% by weight of (meth)acrylate monomer(s);
   from 0.1% to 5% by weight of reducing agent(s);
   from 0.1% to 10% by weight of zinc salt(s) as defined above, preferably chosen from zinc alkanesulfonates, zinc acetate, and mixtures thereof;
   from 2% to 30% by weight of core-shell impact modifier(s);
   from 0% to 40% by weight of urethane-acrylate compound(s);
      relative to the total weight of said component A;
a component B comprising:
   from 1% to 50% by weight of oxidizing agent(s); and
   from 20% to 80% by weight of plasticizer(s);
      relative to the total weight of said component B.

Preferably, the composition according to the invention is an adhesive composition.

### Ready-to-Use Kit

The present invention also relates to a ready-to-use kit, comprising both the component A as defined above and the component B as defined above, packaged in two separate compartments. It can, for example, be a two-component cartridge.

Indeed, the composition according to the invention can be in a two-component form, for example within a ready-to-use kit, comprising both the component A in a first compartment or drum and the component B in a second compartment or drum, in proportions suitable for direct mixing of the two components, for example using a metering pump.

According to one embodiment of the invention, the kit additionally comprises one or more means for mixing the components A and B. Preferably, the mixing means are chosen from metering pumps or static mixers with a diameter suited to the amounts used.

### Uses of the Compositions

The present invention also relates to the use of a composition as defined above as adhesive, mastic or coating, preferably as adhesive.

The invention also relates to the use of said composition in the repair and/or the structural or semi-structural adhesive bonding of materials in the transportation, motor vehicle (car, bus or truck), electronics, assembly, wind power, marine or construction field.

The present invention also relates to a process for assembling two substrates by adhesive bonding, comprising:
coating at least one of the two substrates to be assembled with a composition obtained by mixing components A and B as defined above; and then
effectively bringing the two substrates into contact;
the crosslinking of the composition.

The crosslinking step can be carried out at a temperature between 0° C. and 200° C., preferably between 10° C. and 150° C., preferably between 23° C. and 80° C. and in particular between 20° C. and 25° C.

The appropriate substrates are, for example, inorganic substrates, such as concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters, epoxy resins; substrates made of metal and composites coated with paint.

The compositions according to the invention advantageously allow polymerization which takes place at the surface and at depth. In addition, the surface of the crosslinked compositions dries quickly and is not tacky, which advantageously makes it possible to increase the productivity of industrial processes and the appearance of the adhesive bonds by limiting the incorporation of dust.

The compositions according to the invention advantageously exhibit, after crosslinking, good adhesive properties.

In addition, the use of zinc salt in the compositions according to the invention advantageously makes it possible to control the open time according to the intended application. For example, the use of zinc carboxylate according to the invention advantageously makes it possible to reduce the open time and therefore to accelerate the reaction.

All the embodiments described above may be combined with each other. In particular, the various abovementioned constituents of the composition, and notably the preferred embodiments of the composition, may be combined with each other.

In the context of the invention, the term “of between x and y” or “ranging from x to y” is understood to mean an interval in which the limits x and y are included. For example, the range “between 0% and 25%” notably includes the values 0% and 25%.

The invention is now described in the following implementation examples, which are given purely by way of illustration and should not be interpreted in order to limit the scope thereof.

### Examples

The following ingredients were used:
Bisomer® PTE (CAS number: 103671-44-9) sold by GEO Specialty Chemicals;
methyl methacrylate (MMA) sold by Aldrich;
MBS CLEARSTRENGTH® XT100 sold by ARKEMA is a core-shell impact modifier based on MMA-butadiene-styrene;
CN®981 sold by Sartomer is a urethane-acrylate with functionality 2 and Mw of 2000 g/mol;
zinc methanesulfonate (CAS 33684-80-9) sold by Aldrich;
Valikat® ZN 1910 sold by Umicore is zinc(II) neodecanoate;
zinc acetate dihydrate (CAS 5970-45-6) sold by Aldrich;
methacrylic acid sold by Aldrich;
SR9054 (CAS no.: 1628778-81-3) sold by Sartomer is a mixture of methacrylates comprising phosphonic acid functions;
HDK® N20 sold by Wacker is a fumed silica;
TALCRON® CL40 sold by Minerals Girona is a magnesium hydrosilicate;
Peroxan™ BP 50 sold by Pergan is a 50% benzoyl peroxide paste;
Crayvallac® SLT sold by Arkema is a micronized amide wax used as rheological agent;
Vikoflex® 7170 sold by Arkema is an epoxidized soybean oil used as a plasticizer.

### Example 1: Preparation of the Compositions

The ingredients constituting the component A are added in the proportions shown in the following table, at a temperature of 23° C., to a reactor kept constantly stirred and under nitrogen.

The various ingredients constituting the component B are mixed in the proportions shown in the following table, at a temperature of 2300, in a reactor kept constantly stirred and under nitrogen.

Compositions nos. 1 to 3

| Component A | | Component B | |
|---|---|---|---|
| | % by weight | | % by weight |
| | (relative to the | | (relative to the |
| Ingredients | total weight of A) | Ingredients | total weight of B) |
| MMA | 44.33 | PEROXAN ™ | 35 |
| | | BPO | |
| Clearstength ® | 10 | VIKOFLEX ® | 62 |
| XT100 | | 7170 | |
| CN981 | 27.8 | Crayvallac ® | 10 |
| | | SLT | |
| Methacrylic acid | 1.11 | | |
| SR9054 | 2.22 | | |
| HDK ® N20 | 5.55 | | |
| Crayvallac ® | 3.55 | | |
| SLT | | | |
| Talkron ® CL40 | 3.22 | | |
| Bisomer ® PTE | 1.11 | | |
| Zinc salt* | 1.11 | | |
| | 100% | | 100% |

Three different compositions were prepared with various zinc salts:

| Zinc salt | |
|---|---|
| Zinc acetate dihydrate | Composition no. 1 |
| VALIKAT ® ZN 1910 | Composition no. 2 |
| Zinc methane sulfonate | Composition no. 3 |

The mixing is carried out at a temperature of approximately 2300, in a volume ratio of 10:1 (component A:component B) with a static mixer.

### Example 2: Results

Test of Polymerization Temperature and Time after Mixing Components A and B

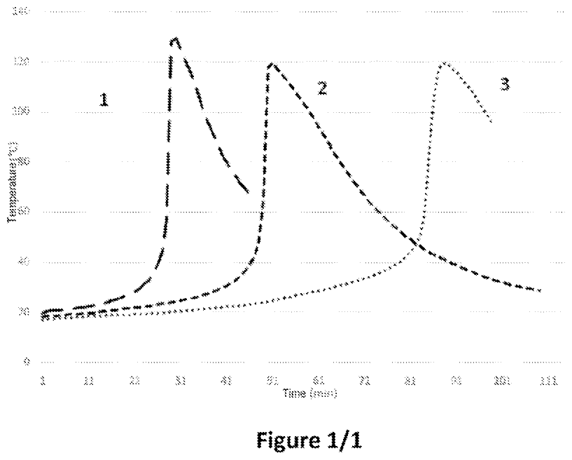

FIG. 1 represents the temperature T (in ° C.)=f (time in minutes) which was obtained with compositions no. 1, no. 2 and no. 3 (curves 1, 2 and 3 respectively). The test is carried out using a sacrificial thermocouple in a mixture volume of 30 ml. This test makes it possible to determine the exothermicity of the reaction and the lag time, that is to say the time required by the sample in order to begin to polymerize. This time is the pot life.

FIG. 1 shows that composition no. 1 with zinc acetate dihydrate results in an exotherm (temperature peak) in a short time of the order of 30 minutes, whereas it is more than 90 minutes with composition no. 3. Thus, for the same composition, it is possible to vary the open time according to the desired application, by modifying the nature of the zinc salt. Composition no. 3, with a long open time, would be able to be used advantageously in the wind power field where the large blades require an open time of at least one to two hours to adhesively bond such parts.

### Inhibition Result

The inhibition of the adhesive is observed by contact with the surface of the two-component mixture which should be dry and tack-free, using a tongue depressor or a strip of paper. In terms of inhibition, the following table groups together the results with compositions no. 1, no. 2 and no. 3:

| Composition no. | results |
|---|---|
| 1 | ++ |
| 2 | + |
| 3 | + |

1-14. (canceled)

15. A two-component crosslinkable composition comprising:
a component A comprising:
a (meth)acrylate monomer;
a reducing agent; and
a zinc salt selected from the group consisting of zinc alkanesulfonates, zinc acetate, and mixtures thereof; and
a component B comprising an oxidizing agent.

16. The composition as claimed in claim 15, characterized in that the reducing agent is selected from the group consisting of tertiary amines, sodium metabisulfite, sodium bisulfite, transition metals, azo compounds, alpha-aminosulfones, and mixtures thereof.

17. The composition as claimed in claim 15, characterized in that the reducing agent is a tertiary amine, having the formula (I) or (II) below: 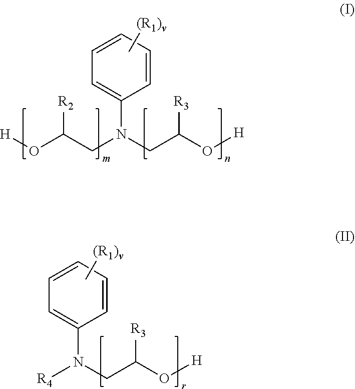
wherein:
m and n are, independently of one another, an integer ranging from 1 to 150;
r is an integer ranging from 1 to 200;
R₁ represents a radical selected from the group consisting of a saturated or unsaturated and linear or branched alkyl comprising from 1 to 20 carbon atoms; of a (hetero)aryl comprising from 6 to 12 carbon atoms; of a cycloalkyl comprising from 3 to 12 carbon atoms;
v represents an integer ranging from 0 to 5;
R₂ and R₃ represent, independently of one another, a halogen atom, a hydrogen atom or a linear or branched alkyl group comprising from 1 to 12 carbon atoms, said alkyl group being optionally interrupted by at least one oxygen atom;
R₄ represents a hydrogen atom, an arylalkyl group or a linear or branched alkyl group comprising from 1 to 20 carbon atoms;
on the condition that m+n>2.

18. The composition as claimed in claim 15, characterized in that component A comprises a total content of reducing agent(s) ranging from 0.1% to 5%, by weight relative to the total weight of said component A.

19. The composition as claimed in claim 15, characterized in that the zinc alkanesulfonates have one of the formulae (III) or (IV) below: 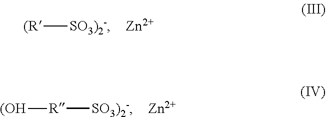
wherein R′ represents a linear or branched hydrocarbon radical comprising from 1 to 18 carbon atoms, and R″ represents a linear or branched hydrocarbon radical comprising from 2 to 18 carbon atoms.

20. The composition as claimed in claim 15, characterized in that the total content of zinc salt(s) in component A ranges from 0.1% to 10%, by weight relative to the total weight of said component A.

21. The composition as claimed in claim 15, characterized in that the (meth)acrylate monomer is chosen from the group consisting of:
compounds having formula (A) below: 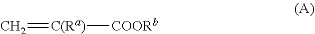
wherein:
R^{A} represents a hydrogen atom or an alkyl group comprising from 1 to 4 carbon atoms;
R^{b} is selected from the group consisting of alkyls, cycloalkyls, alkenyls, cycloalkenyls, alkylaryls, arylalkyls and aryls, it being possible for said alkyls, cycloalkyls, alkenyls, cycloalkenyls, alkylaryls, arylalkyls or aryls to be optionally substituted and/or interrupted by at least one silane, one silicone, one oxygen, one halogen, one carbonyl, one hydroxyl, one ester, one urea, one urethane, one carbonate, one amine, one amide, one sulfur, one sulfonate or one sulfone;
polyethylene glycol di(meth)acrylates;
polypropylene glycol di(meth)acrylates;
tetrahydrofuran (meth)acrylates;
hydroxyalkyl (meth)acrylates;
hexanediol di(meth)acrylate;
trimethylolpropane tri(meth)acrylate;
diethylene glycol di(meth)acrylate;
triethylene glycol di(meth)acrylate;
tetraethylene glycol di(meth)acrylate;
dipropylene glycol di(meth)acrylate;
di(pentamethylene glycol) di(meth)acrylate;
diglyceryl tetra(meth)acrylate;
tetramethylene di(meth)acrylate;
ethylene di(meth)acrylate;
bisphenol A mono- and di(meth)acrylates;
bisphenol F mono- and di(meth)acrylates; and
mixtures thereof.

22. The composition as claimed in claim 15, characterized in that the (meth)acrylate monomer is selected from the group consisting of methyl (meth)acrylate, ethyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, 3-vinylcyclohexyl (meth)acrylate, bornyl (metha)crylate, 2,4,5-tri-t-butyl-3-vinylcyclohexyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, and mixtures thereof.

23. The composition as claimed in claim 15, characterized in that component A comprises a total content of (meth)acrylate monomer(s) ranging from 20% to 80%, by weight relative to the total weight of said component A.

24. The composition as claimed in claim 15, characterized in that it comprises at least one additional ingredient selected from the group consisting of catalysts, fillers, antioxidants, light stabilizers/UV absorbers, metal deactivators, antistatic agents, antifogging agents, foaming agents, biocides, plasticizers, lubricants, emulsifiers, dyes, pigments, rheological agents, impact modifiers, adhesion promoters, optical brighteners, flame retardants, antisweating agents, nucleating agents, solvents, and mixtures thereof.

25. The composition as claimed in claim 15, characterized in that it comprises:
a component A comprising:
from 20% to 80% by weight of (meth)acrylate monomer(s);
from 0.1% to 5% by weight of reducing agent(s);
from 0.1% to 10% by weight of zinc salt(s) as defined in claim 15;
from 2% to 30% by weight of core-shell impact modifier(s); and
from 0% to 40% by weight of urethane-acrylate compound(s);
relative to the total weight of said component A;
a component B comprising:
from 1% to 50% by weight of oxidizing agent(s); and
from 20% to 80% by weight of plasticizer(s);
relative to the total weight of said component B.

26. The composition as claimed in claim 15, characterized in that component A/component B volume ratio ranges from 100/5 to 1/1.

27. An adhesive, mastic or coating comprising the composition as defined in claim 15.

28. A process for assembling two substrates by adhesive bonding, comprising:
coating at least one of the two substrates to be assembled with a composition obtained by mixing components A and B as defined in claim 15; and then
effectively bringing the two substrates into contact; and
crosslinking the composition.
